(19) United States
(12) Patent Application Publication
(10) Pub. No.: US 2011/0006462 A1
(43) Pub. Date: Jan. 13, 2011

(54) METHOD AND SYSTEM FOR MOLDLESS BOTTLE MANUFACTURING

(76) Inventors: Don W. Cochran, Gates Mills, OH (US); Noel E. Morgan, JR., North Olmsted, OH (US); Denwood F. Ross, III, Austinburg, OH (US)

Correspondence Address: FAY SHARPE LLP, 1228 Euclid Avenue, 5th Floor, The Halle Building, Cleveland, OH, 44115, US

(21) Appl. No.: 12/834,742

(22) Filed: Jul. 12, 2010

Related U.S. Application Data
(60) Provisional application No. 61/224,822, filed on Jul. 10, 2009.

(51) Int. Cl. H05B 6/00

(52) U.S. Cl. 264/454

(57) ABSTRACT

A method and/or system for forming a plastic bottle from a preform without the use of a mold or a complete mold are provided. The technique includes selectively injecting heat into the preform using narrowband irradiation devices emitting irradiation in a narrow wavelength band matching desired absorptive characteristics of selective portions of the preform according to a predetermined heat signature to achieve a three-dimensional heat profile in the preform. The heat profile corresponds to a desired shape of a finished bottle and facilitates self-limiting stretching of the selected portions of the preform to achieve the desired shape. Using the technique, air is selectively injected into the preform to form in free air the finished bottle having the desired shape.

This application is based on and claims priority to U.S. Provisional Application No. 61/224,822, filed Jul. 10, 2009, which is incorporated herein by reference in its entirety.

### BACKGROUND

The plastic PET bottle manufacturing world has developed a number of techniques for blow-forming their bottles with molds. PET is typically blown with a technique called stretch blow-forming. The stretch blow-forming process uses an interim step between the resin and the blow molded bottle which is known as a preform. The preform is typically injection molded but is sometimes manufactured by impact extrusion or other process. In any event, it is the interim step between the melted resin and a blown bottle. A preform typically consists of two major areas which are separated by a neck ring. The threaded area, or finish as it is often known, is the portion onto which a cap is applied to close and seal the bottle. It is the intent that this finish portion of the preform would not be dimensionally altered in the blow-forming process. The other portion of the preform which lies beyond the neck ring or support ring as it is often known divider, is the body of the preform. The body portion of the preform is typically heated until it is in a soft or pliable state such that it can be stretched into the bottles' final shape in the blow-forming process. In order to heat the body of the preform to the desired pliable or blowing state temperature, quartz lamp ovens are conventionally applied. Quartz ovens typically have very poor specificity in terms of where the heat is ultimately directed within the preform. As a result of this, more heat is typically introduced into the preform than is actually necessary to blow the bottle and higher pressures are typically used in the mold than might be necessary as well.

It is the subject of this patent application to introduce a new concept called Digital Heat Injection (DHI) to precisely place heat in the body of the preform to substantially improve the injection blow molding process. DHI heating is the subject of several patents and/or applications including U.S. Pat. No. 7,425,296; U.S. Ser. No. 11/448,630, filed Jun. 7, 2006; U.S. Ser. No. 12/135,739, filed Jun. 9, 2008 and U.S. provisional patent application no. 61/157,799, filed Mar. 5, 2009, which are hereby incorporated by reference in their entirety into the present disclosure.

It is the intention of this patent application to teach the skillful use of Digital Heat Injection (DHI) so that it is possible to dramatically reduce at least one of the amount of resin, the blowing pressures, the joules of heat required, and the sophistication of the molds required. It will further teach that by the skillful use of DHI, it is possible to blow some types of bottles without a mold at all. This approach is quite revolutionary for the bottle blowing world because they have been blowing bottles by the conventional means for several decades.

### BRIEF DESCRIPTION

In one aspect of the presently described embodiments, the method comprises selectively injecting heat into the preform using narrowband semiconductor irradiation devices emitting irradiation in narrow wavelength bands matching desired absorptive characteristics of selected portions of the preform according to a predetermined heat signature to achieve a three-dimensional heat profile in the preform, wherein the heat profile corresponds to a desired shape of a finished bottle and facilitates self-limiting stretching of the selected portions of the preform to achieve the desired shape, and, selectively injecting air into the preform to form in free air the finished bottle having the desired shape.

In another aspect of the presently described embodiments, the narrowband irradiation devices are configured in at least one array and are selectively controlled to control heat injection into the selected portions of the preform.

In another aspect of the presently described embodiments, the predetermined heat signature is a function of power levels of corresponding narrowband irradiation devices in an array.

In another aspect of the presently described embodiments, the predetermined heat signature is a function of at least one of size of the narrowband irradiation devices and geometric arrangement of the devices.

In another aspect of the presently described embodiments, the predetermined heat signature is a function of locus of output irradiation patterns from narrowband irradiation devices comprising an array of the narrowband irradiation devices.

In another aspect of the presently described embodiments, the predetermined heat signature is a function of granularity of control of the narrowband irradiation devices,

In another aspect of the presently described embodiments, the predetermined heat signature is a function of wavelength of irradiation emitted by the narrowband irradiation devices.

In another aspect of the presently described embodiments, the predetermined heat signature is a function of a configuration of the narrowband irradiation devices.

In another aspect of the presently described embodiments, the predetermined heat signature is a function of relative distances of the narrowband irradiation devices to the preform.

In another aspect of the presently described embodiments, the method further comprises rotating the perform during irradiation.

In another aspect of the presently described embodiments, the selective injecting of heat into the rotating preform achieves an asymmetrical three-dimensional heat profile.

In another aspect of the presently described embodiments, the method further comprises implementing a stretch rod operative to provide stretching of the preform in an axial direction while air provides stretching in other directions.

In another aspect of the presently described embodiments, the method further comprises providing a partial mold to restrict dimensions of the finished bottle during the selective air injection.

In another aspect of the presently described embodiments, the at least one array is arranged as a plurality of arrays around a circumference of the preform.

In another aspect of the presently described embodiments, the selective injecting of heat into the preform by the plurality of arrays achieves an asymmetrical three-dimensional heat profile.

In another aspect of the presently described embodiments, the system comprises a configuration of narrowband semiconductor irradiation devices operative to selectively inject heat into the preform by emitting irradiation in narrow wavelength bands matching desired absorptive characteristics of selective portions of the preform according to a predetermined heat signature to achieve a three-dimensional heat profile in the preform, wherein the heat profile corresponds to a desired shape of a finished bottle and facilitates self-limiting stretching of the selected portions of the preform to achieve the desired shape, a mechanism operative to selectively inject air into the perform to form in free air the finished bottle having the desired shape, and a controller operative to control the configuration and the mechanism.

In another aspect of the presently described embodiments, the narrowband irradiation devices are configured in at least one array and are operative to be selectively controlled to inject selected amounts of heat into the selected portions of the preform.

In another aspect of the presently described embodiments, the predetermined heat signature is a function of power levels of corresponding narrowband irradiation devices of an array.

In another aspect of the presently described embodiments, the predetermined heat signature is a function of at least one of size and geometric arrangement of the narrowband irradiation devices.

In another aspect of the presently described embodiments, the predetermined heat signature is a function of locus of output irradiation patterns from narrowband irradiation devices comprising and array of the narrowband irradiation devices.

In another aspect of the presently described embodiments, the predetermined heat signature is a function of granularity of control of the narrowband irradiation devices.

In another aspect of the presently described embodiments, the predetermined heat signature is a function of wavelength of irradiation emitted by the narrowband irradiation devices.

In another aspect of the presently described embodiments, the predetermined heat signature is a function of a configuration of the narrowband irradiation devices.

In another aspect of the presently described embodiments, the predetermined heat signature is a function of relative distances of the narrowband irradiation devices to the preform.

In another aspect of the presently described embodiments, the system further comprises means for rotating the perform during irradiation to achieve one of an asymmetrical heat profile or a symmetrical heat profile.

In another aspect of the presently described embodiments, the system further comprises a stretch rod operative to provide stretching of the preform in an axial direction while air provides stretching in other directions.

In another aspect of the presently described embodiments, the system further comprises a partial mold operative to restrict a dimension of the preform during the selective injection of air.

In another aspect of the presently described embodiments, the at least one array is arranged as a plurality of arrays around a circumference of the preform.

In another aspect of the presently described embodiments, the plurality of arrays emits irradiation to achieve an asymmetrical three-dimensional heat profile in the preform.

### BRIEF DESCRIPTION OF THE DRAWINGS

FIG. 1 is an illustration of a system according to the presently described embodiments;

FIG. 2 is an illustration of a system according to the presently described embodiments;

FIG. 3 is an illustration of a system according to the presently described embodiments;

FIG. 4 is a flowchart illustrating a method according to the presently described embodiments; and,

FIGS. 5(a)-(d) is an illustration of system(s) according to the presently described embodiments.

### DETAILED DESCRIPTION

PET material has unique properties of which the stretch blow molding process takes good advantage. One of the properties that is very interesting with PET or polyethylene terephthalate material is that it has a well known stress strain curve. So, as the material is stretched, crystallization takes place. Effectively, the stretched PET material, because of the crystallites that are formed in the stretching process, become stronger than the unstretched PET material. It is said that when PET material is stretched that it becomes ‘oriented’ which means that with material movement crystallites are formed which have a directionality to them. In bottles, there is typically axial and hoop stretching. The amount of stretch or strain which can occur with a given amount of stress is a function of the heat of the material when stretched. Material which has more heat in it can easily stretch further and with less exerted force. If the PET material is forced by virtue of additional stress or pressure to stretch beyond the natural limits for that amount of heat, then whitening will occur which indicates that so much crystallization is occurring that it is actually beginning to block visible light. This amount of crystallization will spoil the usual beautiful clear appearance of the PET and will often adversely affect its mechanical properties as well by making it more brittle, allowing for catastrophic failures.

By extension of this concept, the PET material will stretch at a given pressure or strain until it reaches its natural limit for the existing heat content, e.g. the material has a self-limiting extent to which it will stretch for a given heat content above the glass transition temperature. Therefore, it is easy to understand that if the latent heat content is perfectly uniform and the geometric dimensions of the preform are uniform, then it is likely for any given pressure, the bottle will expand uniformly.

The concepts of preform design to make a particular bottle in a particular mold are a well understood combination of art and science. There are for example, many rules of thumb that are used in preform design incorporating such things as maximum hoop stretch ratio, maximum axial stretch ratio, arial stretch ratio which is the product of hoop ratio times axial ratio and so on. The gate area of the preform which is the end where the material was injected into the injection molding dye is typically controlled so that it is approximately 65% to 100% the thickness of the body of the preform. Preforms must be designed with negative taper typically no less than 0.07 degrees so that the injection molding core will slide out easily as it is removed from the molding dye. The support ledge or neck ring must be approximately 3 mm larger in diameter than the body of the preform so that it can hang on the material transport rails in the bottle manufacturing process. These are just a few, but there are many many design rules which are applicable to preform and bottle design. This is a well established body of knowledge that need not be described herein.

What is not well understood in bottle and preform design is how the preforms and bottles could and should be designed differently if they are designed to be heated with the precision available with the Digital Heat Injection (DHI) technique. Fundamentally, because stretch is a direct function of temperature, being able to precisely place different areas of temperature, can make a dramatic difference in the ease of forming a bottle to a particular shape. Self-limiting stretching of the material allows it to stretch to a defined extent based on the heat content and/or heat distribution. The 3-D heat distribution will be a factor in the final shape if the stretching is not limited by a mold. Being able to design and implement an exact 3-D temperature profile, is a huge step forward in the bottle manufacturing process. As bottle designs get more and more complex, the manufacturer of the bottle must currently put enough heat into the preform that it can handle the most severe stretch that will be needed in a local area. For example, many bottles are now ribbed. A ribbed bottle requires slightly more input energy for heating than a non-ribbed bottle but it is currently manufactured in that way because there is no alternative technology. Digital Heat Injection (DHI) on the other hand, allows the manufacturer to program the areas of higher and lower heat concentration that are desired and thus creates an energy saving condition. It not only saves energy in the amount of heat that is necessary to bring the preform up to blowing temperature but it also can save substantial energy by reducing the maximum blowing pressure that is necessary to make a given bottle. If the 3-D heat profile is already in the preform to allow it to naturally flow without as much pressure, then there will be a natural propensity for the PET material to flow more as a function of the heat which it will do as a lower blowing pressure. The maximum blowing pressure in modern stretch blow-forming machines is often in the neighborhood of 40 bars.

Square, rectangular, and oval bottles are all examples of preforms and bottles that would benefit from a 3-D heat profile that can be custom suited for the application. The PET material near the corners of a square bottle needs to stretch further than the material that is in the center of each wall, Many bottles are being designed with substantial shoulder and waist configurations. Those configurations can benefit substantially from having the heat exactly where it needs to be to allow for lower energy blowing.

Although implementation may vary, one way of implementing the presently described embodiments is to provide individual radiation emitters in suitable arrays. The emitters could be controlled individually or as blocks. Or, the emitters may not be provided in arrays whereby they would be individually controllable and locatable. In at least one form, the emitters take the form of narrowband wavelength irradiation devices (such as narrowband semiconductor irradiation devices) that matches desired absorptive characteristics of the material from which the target, or bottle, is formed or the absorptive characteristics of specified portions of the bottles, or preforms. The absorption characteristics may be obtained in a variety of manners including absorption v. wavelength curves for specific materials or through experimentation or through manufacturers specifications. For PET, in some example applications, 1650 nanometers will be a desired absorption wavelength. In other example applications, certain selected bands between, for example, 1620 nanometers and 2500 nanometers will suffice. The patents and applications referenced above describe such devices and their operation in DHI systems in greater detail, but the configuration of such devices and operation of such devices will be a function of the desired wavelengths and application parameters. Note that the desired wavelengths may vary for the same material depending on a variety of other factors including the actual implementation. The devices could be diodes, semiconductor devices, solid-state devices, laser diodes, LEDs, radiation emitting devices (REDs) and/or other variants that perform to emit narrow wavelength bands of radiation toward a target.

Another way of implementing the Digital Heat Injection (DHI) technology is to irradiate through fiber optics the ends of which terminate forming a row or a line in a block which holds their alignment in a fixed position. Each fiber is connected to at least one multi mode power diode or other semiconductor device which can be controlled individually.

Often the devices contemplated herein are controlled in larger strings or banks but the technology certainly exists to control down to the level of each solid-state narrow band irradiation device individually. Some readers would be familiar with a line scan camera which is receiving data on a one by n array of sensitive pixels. A continuous row of irradiating fibers might be thought of as the opposite of a line scan camera in that it is putting out energy in a programmable line as opposed to receiving it. Extending the analogy a little further, if the line scan camera were a gray-scale camera, it would be outputting a signature whose gray scale varies as a function of distance from one end of the array. Reversing the concept would allow us to put out a signature whose irradiation intensity varies as a function of distance from one end of the array of fiber optics or the emitters. And extending the analogy even further, if we were imaging a cylindrical product such as a can or bottle, we could read a stripe of signature information for each stripe around the perimeter of the cylindrical item that we are imaging.

With the DHI analogy, as we rotate the preform for irradiation, we could output an irradiation signature which varies as a function of distance from one end of the emitter or fiber optic array but then a signature for each stripe of real estate along the length of the bottle around its diameter. This would allow for a fully programmable system that could inject a 3-D heat profile limited only by the imagination of the programmer. The minimum size heat injected resolution would be a direct function of the emitter or fiber size, the divergence angle or the locus of the irradiation patterns of the devices on the array, and the granularity of individual diode control that we designed into the system. The geometric arrangement of the narrowband devices may also be a factor in the heat signature. Also, the signature could be varied as a function of power levels of corresponding devices on the arrays and/or wavelength of such devices, as an alternative or in addition to the physical dimensions and relative distances of the target and array.

If a 3-D heat profile is to be injected which corresponds to mold features, it is very important that the preforms' rotational orientation be maintained as it is transferred from the DHI oven to the corresponding mold, If the 3-D profile does not have a unique radial orientation, then this would not be of great concern. Dimples, beads, swirls, and embossed patterns would be examples of things that may have a 3-D radial orientation such that registration must be maintained precisely.

The concept of a 3-D programmable heat profile has many benefits from the standpoint of increasing bottle quality, and reducing energy costs for both heating and the production of high pressure air. The later two are the largest energy using activities in a PET blow-forming plant.

In one form, a desired 3-D profile of a bottle/preform could be represented in an array of emitters described above. The entire surface could be replicated in the array, i.e. “unwrapped,” so the preform or bottle could simply be rotated as it passes by the array to achieve the desired shape. It will be appreciated that air flow or air introduction into the preform should be taken into account during design set-up and/or control of the system and/or heat profile to ensure that suitable pressure is available to provide consistent and/or symmetrical forming of preforms. The value and/or the rate of change during stretching of the preform may also be factors in this process.

This concept becomes even more useful, however, when it is realized that with careful design and implementation it is possible to blow a PET bottle completely without a mold. This would require precision in the manufacturing of the preform, in the design of the preform, and in the implementation of the Digital Heat Injection process which, in at least one form, facilitates the matching of emitted radiation with the absorptive characteristics of the target or selected portions of the target. It would pay major dividends in that the air pressure required to blow a bottle could be dramatically reduced to a small fraction of the current state-of-the-art. The cost for buying and manufacturing the molds could also be nearly eliminated.

It is anticipated that some substitutive structure may be required to make sure that the bottles would blow straight and squarely. It probably would still be desirable to use a stretch rod to provide for proper axial stretch as well as to supply some structural guiding in the blowing process. If the stretch rod were still engaged in the preform it would help the preform to blow straighter and more squarely.

It might also be desirable to have a much abbreviated base mold section or cup, or a partial mold. For example, this partial mold could work in conjunction with the timing and location of the stretch rod to make sure that the base is formed fully to maintain complete structural integrity.

The elimination of the full clam-shell type blow molding mold would dramatically reduce both the cost and complexity of a stretch blow-forming machine. The preforms and their corresponding bottles would require a more sophisticated design technology in order to make proper bottles. There would also be a requirement to output a sophisticated program to control the Digital Heat Injection (DHI) oven according to the bottle and preform design. For example, the selected wavelength and/or power of the emitters may need to be selected so that only a single wall of the bottle absorbs the radiation, particularly where rotation occurs.

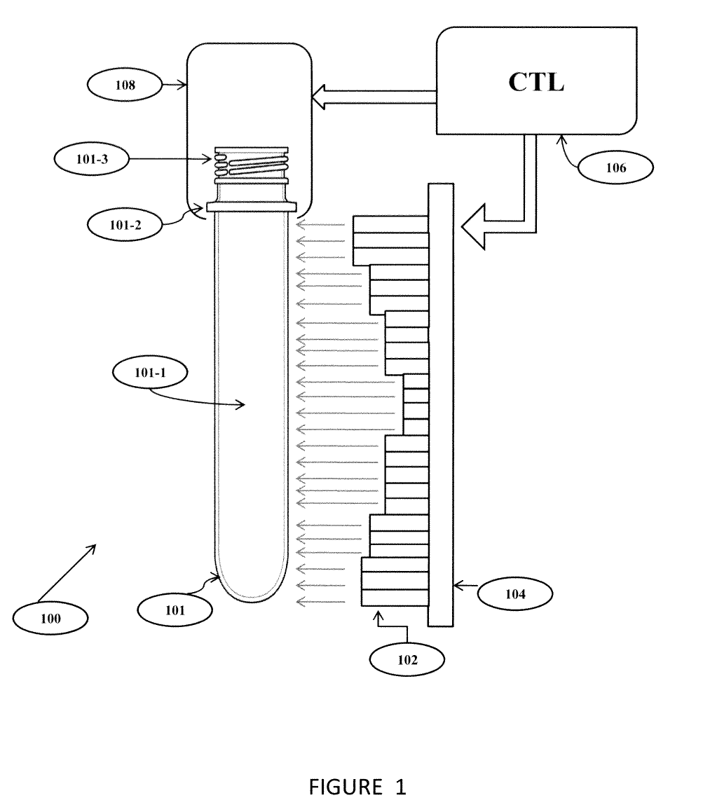

With reference to FIG. 1, one example configuration is shown. As shown, a system 100 includes an array 102 of narrowband irradiation devices matching the desired absorptive characteristics of the target, or bottle or preform, 101. The target 101 can take a variety of forms but, in at least one form, includes a body 101-1, a neck portion 101-2 and a thread portion 101-3. The array 102 resides on a circuit board and/or cooling substrate 104. A controller 106 controls the array to implement the process described above, whereby the array would emit appropriate radiation toward the bottle to heat and re-shape the bottle as desired.

The arrays 102 are configured for selectively injecting heat into the preform using narrowband irradiation devices emitting irradiation in narrow wavelength bands matching desired absorptive characteristics of selected portions of the preform according to a predetermined heat signature to achieve a three-dimensional heat profile in the preform. The heat profile corresponds to a desired shape of a finished bottle and facilitates self-limiting stretching of the selected portions of the preform to achieve the desired shape. Given this precise heat profile, air may be selectively injected into the preform to form in free air (e.g. substantially only an ambient environment without a mold) a finished bottle having the desired shape.

In one form, the distance from the surface of the bottle to the array (or individual element of the array) is engineered to vary as a function of the desired bottle shape as described above. In other forms, the array could include emitters of varying power or wavelength to achieve a desired bottle shape. The physical distance between the array and target may vary or may not vary in these situations.

Also shown is a mechanism 108 to translate and/or rotate the preform into a suitable irradiation zone to be heated and/or processed. In some forms, the preform may be rotated, as mentioned above, to achieve a desired result. Also, as those of skill in the field will appreciate, the mechanism 108, as is merely representatively shown, may also provide the “blowing” devices, e.g. air compressors, to expand the preform after suitable heating and processing. The mechanism 108 make take a variety of forms, and may actually comprise multiple components, but will generally support the preform and seal and clamp the neck and/or thread portion to facilitate the pressure from blowing to bottle. The controlling 106 may be configured to control the mechanism 108, e.g. to control the translation, movement, rotation and blowing of the preform.

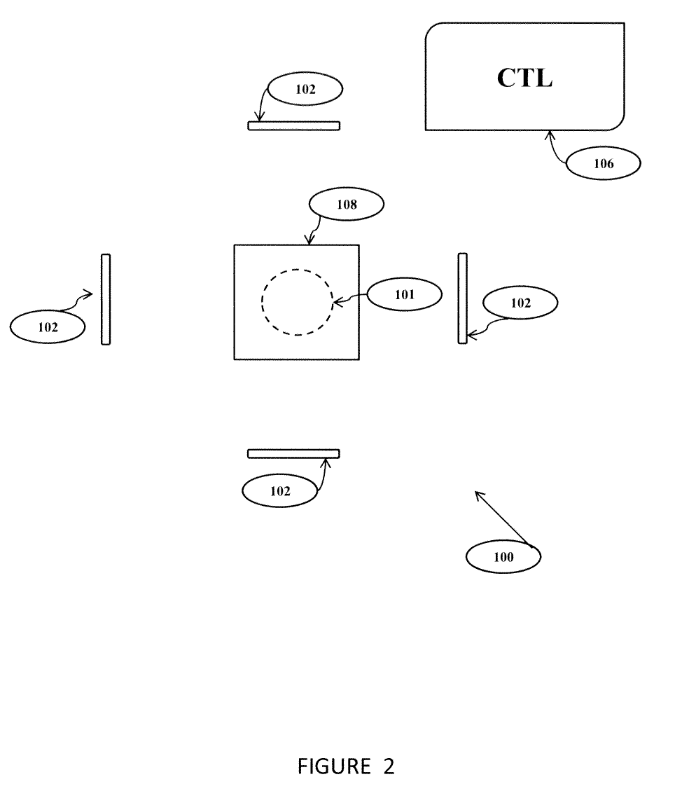

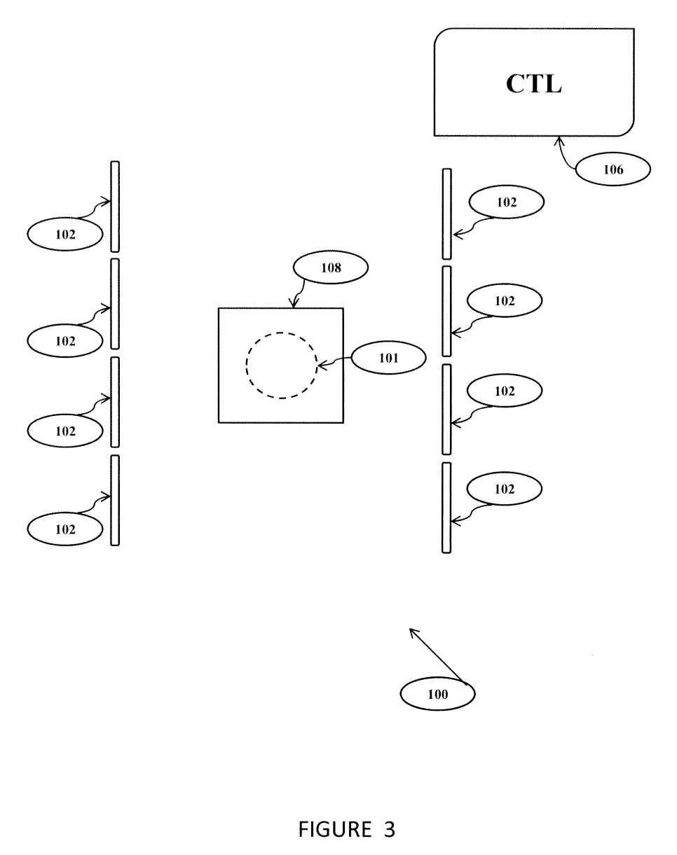

Further, the configuration shown in FIG. 1 may be implemented in other environments and configurations. For example, the array 102 may be duplicated with selected locations around a circumference of the target as shown in FIG. 2. In this configuration, the target 101 may or may not be rotated. In either case, a symmetrical heat profile can be achieved. Without rotation and with an implementation of arrays emitting suitable heat signatures (e.g. as controlled by the controller 106), an asymmetrical three dimensional heat profile can be achieved in the preform. An asymmetrical profile may also be achieved with rotation of the preform if the arrays are controlled (e.g. by the controller 106) to properly emit as the preform rotates. Such an asymmetrical profile results in an asymmetrical finished bottle. Also, the system 100 may be implemented in a linear fashion whereby targets are conveyed past a plurality of arrays 102 along a processing line as shown in FIG. 3. In these situations, arrays 102 may be positioned on both sides of the processing line for the target 101. Also, it should be appreciated that, for ease of reference, only array 102 is shown in FIGS. 2 and 3; however, other components (such as circuit boards or cooling substrate 104) may also be implemented.

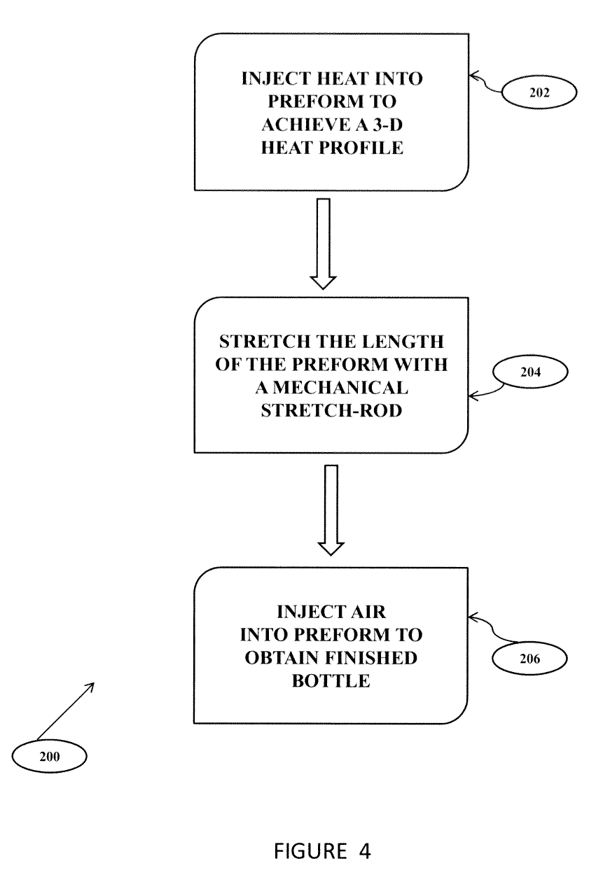

With reference now to FIG. 4, a flowchart illustrating a method according to the presently described embodiments is illustrated. It should be appreciated that the method as described herein as well as other methods according to the presently described embodiments allows may be implemented using a variety of software routines and/or hardware configurations. For example, routines may be executed by the controller 106 shown in the system of FIGS. 1-3, such controller 106 being operative to control the appropriate hardware components (e.g. mechanism 108 and arrays 102) to achieve the objectives of the presently described embodiments.

In one form, a method 200 comprises injecting heat into the preform (at 202) using narrowband irradiation devices emitting irradiation in a narrow wavelength band matching desired absorptive characteristics of the preform according to a predetermined heat signature to achieve a three-dimensional heat profile in the preform. It will be understood that the heat profile corresponds to a desired shape of a desired finished bottle. Any of the configurations shown herein or others may be used to create the heat profile in the preform. To stretch the preform in a linear direction and achieve the appurtenant strength increase, a stretch rod such as a mechanical stretch rod may be implemented to extend the length of the preform before air is injected (at 204). Next, air is selectively injected into the preform (at 206) to form the finished bottle (e.g. in free air) having the desired shape. The stretch rod facilitates stretching in the linear or axial direction while the air injection provides stretching in other directions, for example, the axial direction.

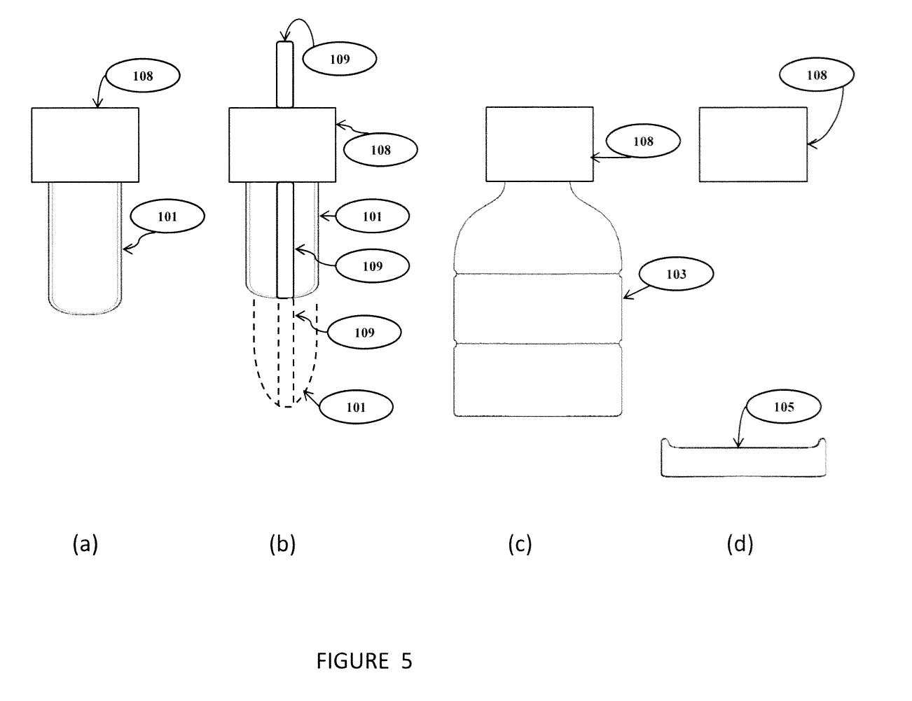

To illustrate, FIGS. 5(a)-(d) show a representation of this process. FIG. 5(a) shows a representative view of a preform 101 held by mechanism 108 (e.g. having been heated to contain the desired heat profile). FIG. 5(b) illustrates the example process of stretching the preform 101 by a stretch rod 109 after injection of the appropriate heat profile. FIG. 5(c) shows a finished bottle 103 held by mechanism 108 after it has been formed in free air. FIG. 5(d) illustrates an alternative system that utilizes a partial mold, or base cup, 105 to restrict a dimension (e.g. length) of the preform as it is being stretched. The partial mold 105 (as noted above) may also provide improved formation for the base of the bottle. Other partial or simplified molds or dimension restrictors may also be used.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method for forming a plastic bottle from a preform, the method comprising:
selectively injecting heat into the preform using narrowband semiconductor irradiation devices emitting irradiation in narrow wavelength bands matching desired absorptive characteristics of selected portions of the preform according to a predetermined heat signature to achieve a three-dimensional heat profile in the preform, wherein the heat profile corresponds to a desired shape of a finished bottle and facilitates self-limiting stretching of the selected portions of the preform to achieve the desired shape; and,
selectively injecting air into the preform to form in free air the finished bottle having the desired shape.

2. The method as set forth in claim 1 wherein the narrowband irradiation devices are configured in at least one array and are selectively controlled to control heat injection into the selected portions of the preform.

3. The method as set forth in claim 1 wherein the predetermined heat signature is a function of power levels of corresponding narrowband irradiation devices on an array of narrowband irradiation devices.

4. The method as set forth in claim 1 wherein the predetermined heat signature is a function of at least one of size of the narrowband irradiation devices and geometric arrangement of the narrowband irradiation devices.

5. The method as set forth in claim 1 wherein the predetermined heat signature is a function of locus of output irradiation patterns from narrowband irradiation devices comprising an array of the narrowband irradiation devices.

6. The method as set forth in claim 1 wherein the predetermined heat signature is a function of granularity of control of the narrowband irradiation devices.

7. The method as set forth in claim 1 wherein the predetermined heat signature is a function of wavelength of irradiation emitted by the narrowband irradiation devices.

8. The method as set forth in claim 1 wherein the predetermined heat signature is a function of a configuration of the narrowband irradiation devices.

9. The method as set forth in claim 1 wherein the predetermined heat signature is a function of relative distances of the narrowband irradiation devices to the preform.

10. The method as set forth in claim 1 further comprising rotating the perform during irradiation.

11. The method as set forth in claim 10 wherein the selective injecting of heat into the rotating preform achieves an asymmetrical three-dimensional heat profile.

12. The method as set forth in claim 1 further comprising implementing a stretch rod operative to provide stretching of the preform in an axial direction while air provides stretching in other directions.

13. The method as set forth in claim 1 further comprising providing a partial mold to restrict dimensions of the finished bottle during the selective air injection.

14. The method as set forth in claim 2 wherein the at least one array is arranged as a plurality of arrays around a circumference of the preform.

15. The method as set forth in claim 14 wherein the selective injecting of heat into the preform by the plurality of arrays achieves an asymmetrical three-dimensional heat profile.

16. A system for forming a plastic bottle from a preform, the system comprising:
a configuration of narrowband semiconductor irradiation devices operative to selectively inject heat into the preform by emitting irradiation in narrow wavelength bands matching desired absorptive characteristics of selective portions of the preform according to a predetermined heat signature to achieve a three-dimensional heat profile in the preform, wherein the heat profile corresponds to a desired shape of a finished bottle and facilitates self-limiting stretching of the selected portions of the preform to achieve the desired shape;
a mechanism operative to selectively inject air into the perform to form in free air the finished bottle having the desired shape; and
a controller operative to control the configuration and the mechanism.

17. The system as set forth in claim 16 wherein the narrowband irradiation devices are configured in at least one array and are operative to be selectively controlled to inject selected amounts of heat into the selected portions of the preform.

18. The system as set forth in claim 16 wherein the predetermined heat signature is a function of power levels of corresponding narrowband irradiation devices on an array of the narrowband irradiation devices.

19. The system as set forth in claim 16 wherein the predetermined heat signature is a function of at least one of size of the narrowband irradiation devices and geometric arrangement of the narrowband irradiation devices.

20. The system as set forth in claim 16 wherein the predetermined heat signature is a function of locus of output irradiation patterns from narrowband irradiation devices comprising an array of the narrowband irradiation devices.

21. The system as set forth in claim 16 wherein the predetermined heat signature is a function of granularity of control of the narrowband irradiation devices.

22. The system as set forth in claim 16 wherein the predetermined heat signature is a function of wavelength of irradiation emitted by the narrowband irradiation devices.

23. The system as set forth in claim 16 wherein the predetermined heat signature is a function of a configuration of the narrowband irradiation devices.

24. The system as set forth in claim 16 wherein the predetermined heat signature is a function of relative distances of the narrowband irradiation devices to the preform.

25. The system as set forth in claim 16 further comprising means for rotating the perform during irradiation to achieve one of an asymmetrical heat profile or a symmetrical heat profile.

26. The system as set forth in claim 16 further comprising a stretch rod operative to provide stretching of the preform in an axial direction while air provides stretching in other directions.

27. The system as set forth in claim 16 further comprising a partial mold operative to restrict a dimension of the preform during the selective injection of air.

28. The system as set forth in claim 17 wherein the at least one array is arranged as a plurality of arrays around a circumference of the preform.

29. The system as set forth in claim 28 wherein the plurality of arrays emits irradiation to achieve an asymmetrical three-dimensional heat profile in the preform.
